(19) United States
(12) Patent Application Publication
(10) Pub. No.: US 2011/0082736 A1
(43) Pub. Date: Apr. 7, 2011

(54) METHOD AND SYSTEM FOR LINKING MOBILE PHONE SERVICES WITH A BANKING PROVIDER

(75) Inventors: Daniel Goldman, Mansfield, MA (US); William Koleszar, Walpole, MA (US)

(73) Assignee: CITIZENS FINANCIAL GROUP, INC., Providence, RI (US)

(21) Appl. No.: 12/606,665

(22) Filed: Oct. 27, 2009

Related U.S. Application Data
(60) Provisional application No. 61/247,780, filed on Oct. 1, 2009.

(51) Int. Cl. G06Q 30/00; G06Q 40/00; G06Q 50/00

(52) U.S. Cl. 705/14.23

(57) ABSTRACT

A method and system is provided that establishes an inventive program across services offered by two vendors. In a preferred embodiment, a bank account is established that is linked with a customer's mobile phone account in a manner that facilitates paperless billing and paperless payment of the mobile phone service bills via services offered by a bank service provider while providing the customer a reward in the form of discounted mobile phone services thereby promoting the goods and services of both vendors simultaneously.

### CROSS-REFERENCE TO RELATED APPLICATIONS

This application claims priority from earlier filed U.S. Provisional Patent Application No. 61/247,780, filed Oct. 1, 2009.

### BACKGROUND OF THE INVENTION

The present invention relates generally to a method and system for cross promoting various disparate services offered by two vendors. More specifically, the present invention relates to a bank account that is linked with a customer's mobile phone account in a manner that facilitates paperless payment of the mobile phone service bills and provides the customer a reward in the form of discounted mobile phone services thereby encouraging that the customer adopt particular packages offered by the vendors while also promoting the goods and services of both vendors simultaneously.

Generally over the past few years customer loyalty programs, which are offered by various vendors to their consumers, have grown exponentially. In this regard, while there are a variety of different structural models on which such loyalty programs are based, they all provide an incentive that is designed to encourage customers to conduct business preferentially with one organization rather than with the various available competitor organizations. For example, credit card processing firms such as Visa and MasterCard, automobile manufacturers, rental car companies, department stores, long distance telephone companies, financial institutions and other organizations all offer a number of different inventive programs for promoting purchases of their own goods and/or services. This type of program may include discount offers for certain catalog items, based on volume of activity in an account. Similarly, such a program may take the form of a point system in which a customer is credited with a number of points for each transaction that they complete. Once a sufficient number of points have accrued, the customer can exchange a portion of those points for goods and/or services. Additionally, other promotional schemes have involved discounts on goods or services, different from those purchased in the account. For example, discount coupons have been offered for airline tickets, based on a minimum level of investment in a bank or savings and loan. Similarly, holders of Visa cards have been offered deeply discounted or free air travel based on a certain level of activity using a general purpose charge card, or have been credited with air miles based on activity in a charge card account.

The difficulty however is that such loyalty systems are limited in flexibility and are narrow in scope. As a result, there is a desire in the industry for more sophisticated loyalty-based systems that are flexible and that facilitate award of the rewards more directly and quickly. There is also a desire for a reward system that capitalizes on relationships between strategic partners in a manner that allows cross promotion of their goods and services through the implementation of such a rewards program.

Accordingly, there is a need for a system that enables a bank service provider or another similarly situated entity to offer an attractive incentive to customers to encourage the use of their account services in exchange for a discount on services offered by a second vendor. There is a further need for a system that enables a bank service provider or another similarly situated entity to offer an attractive incentive to customers in exchange for the customer adopting preferred services offered by the service provider in exchange for a discount on services offered by a second vendor. There is still a further need for a system that allows a bank service provider to cross promote with a second vendor in a manner that creates increased customer loyalty and brand awareness thereby deepening the customer relationship with the two program providers.

### BRIEF SUMMARY OF THE INVENTION

In this regard, the present invention provides a method and system that facilitates the cross promotion services offered by two vendors. In a first preferred embodiment, a bank account is established that is linked with a customer's mobile phone account in a manner that facilitates paperless billing and paperless payment of the mobile phone service bills via services offered by a bank service provider while providing the customer a reward in the form of discounted mobile phone services thereby promoting the goods and services of both vendors simultaneously.

In operation the method and system provides that a customer establishes a new account with a bank service provider. At the time of account enrollment, the customer also establishes the ability to conduct online banking and bill payment. The customer is then provided with a code, voucher, coupon or the like that is redeemable for a mobile phone or an upgrade to an existing mobile phone.

Once the new bank account and mobile phone account are established they are linked by the customer enrolling their mobile phone account for receipt of electronic bills within their bank account. Further linking between the devices may include the downloading of bank service provider software to the mobile phone such as for example an ATM/Branch locater or any other bank provider software that establishes a link between the mobile phone and the bank service provider or enrollment of the mobile phone account for receipt of texted bill alerts.

Bank accounts and mobile phones that are linked in this manner then become eligible for an incentive or discounted service. For example in one embodiment, the phone provider may provide a service such as unlimited text messaging for free. This discount or promotion may be processed in a variety of different manners. The mobile phone provider may absorb all or a portion of the cost of similarly, the bank service provider may absorb all or a portion of the cost. Further, the services may be offered for free, at a discount or rebated.

In a preferred embodiment, the bank provider identifies electronic bill payments originated to the mobile phone provider from a linked account and provides a listing of such transactions to the mobile phone provider in the form of a file, list or database transfer. The mobile phone provider then provides a credit against the customer's mobile phone bill for the value of the free or discounted services. If the bank service provider is to absorb the cost of the discount, the mobile phone provider then charges the bank service provider at least a portion of the expense associated with the discounted services.

Accordingly, it is an object of the present invention to provide a method and system that enables a bank service provider or another similarly situated entity to offer an attractive incentive to customers to encourage the use of their account services in exchange for a discount on services offered by a second vendor. It is a further object of the present invention to provide a system that enables a bank service provider or another similarly situated entity to offer an attractive incentive to customers in exchange for the customer adopting preferred services offered by the service provider in exchange for a discount on services offered by a second vendor. It is still a further object of the present invention to provide a method and system that allows a bank service provider to cross promote with a second vendor in a manner that creates increased customer loyalty and brand awareness thereby deepening the customer relationship with the two program providers.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a flow chart depicting the method of the present invention; and

FIG. 2 is an apparatus depicting one possible embodiment for a system to implement the method of the present invention.

### DETAILED DESCRIPTION OF THE INVENTION

Now turning to the method and system of the present invention in detail. As can be understood, the present invention most generally provides a method and system that is structured in a manner that facilitates the cross promotion services offered by two vendors. In a first preferred embodiment, a bank account is established that is linked with a customer's mobile phone account in a manner that facilitates paperless billing and paperless payment of the mobile phone service bills via services offered by a bank service provider while providing the customer a reward in the form of discounted mobile phone services thereby promoting the goods and services of both vendors simultaneously. Further, while a specific embodiment relating to a mobile phone is described herein it should be appreciated that any service provider could be substituted in place of the mobile phone service provider without changing the scope or intent of the inventive process.

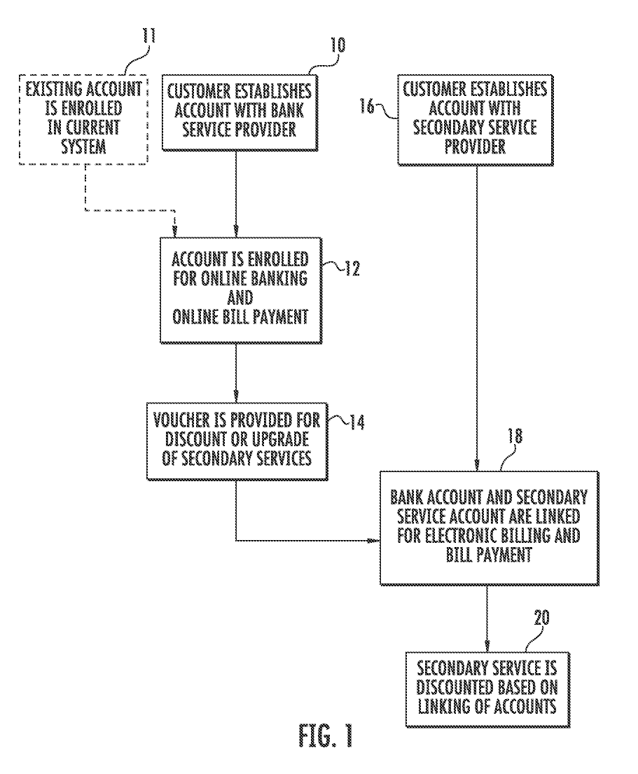

As depicted at FIG. 1, in its most general operation, the method and system provides that a customer establishes a new account with a bank service provider 10. Alternately, the bank service provider may allow the customer to convert or enroll an existing account 11 into the method and system of the present invention. At the time of account enrollment, the customer also establishes the ability to conduct online banking and bill payment 12. The customer is then provided with a code, voucher, coupon or the like 14 that is employed in connection with obtaining services from a second vendor such as a voucher a mobile phone or an upgrade to an existing mobile phone for example. In addition, the customer establishes an account with a secondary vendor for new or upgraded secondary services 16.

Once the new bank account 10 and secondary services 16 are established they are linked with one another for receipt of electronic bills for the secondary service within their bank account 18. Using the mobile phone example, they are linked by the customer enrolling their mobile phone account for receipt of electronic bills within their bank account. Further linking between the account and the secondary service provider may include the downloading of bank service provider software such as for example loading an ATM/Branch locater or any other bank provider software to the mobile phone that establishes a link between the mobile phone and the bank service provider or enrollment of the mobile phone account for receipt of texted bill alerts.

Bank accounts 10 and secondary services 16 that are linked 18 in this manner then become eligible for an incentive or discounted service 20. For example in one embodiment, a secondary service provider such as a mobile phone provider may provide a service such as unlimited text messaging for free. The discount or promotion provided in connection with the disclosure of the present invention may be processed in a variety of different manners. The secondary service provider may absorb all or a portion of the cost of similarly, the bank service provider may absorb all or a portion of the cost. Further, the secondary services may be offered for free, at a discount or rebated.

In a preferred embodiment, the bank provider identifies all of the electronic bill payments that are originated as payments to the mobile phone provider from a linked account. The bank provider then provides a listing of such transactions to the mobile phone provider in the form of a file, list or database transfer. The mobile phone provider then provides a credit against the corresponding customer's mobile phone bill for the value of the free or discounted services. If the bank service provider is to absorb the cost of the discount, the mobile phone provider then charges the bank service provider at least a portion of the expense associated with the discounted services.

It should be appreciated by one skilled in the art that while secondary services are described herein in the context of mobile phone services, such disclosure is meant to be illustrative and not limiting on the scope of the invention. Other secondary services may take the form of cable television, internet, alarm company monitoring, daycare, car purchase/leasing, mortgage, etc. Similarly, while a discount or incentive was described as free text messaging services, this also was meant only to be illustrative of the general concepts of the present invention as any type of discount or incentive previously available in the art or made available in the future are considered to fall within the scope of the present invention. The novelty of the present invention relates to the manner in which the discount incentive program is offered and not in the particularity of the services or discounts themselves.

While one embodiment is described above relating generally to bank account, it should be appreciated that, there are many other primary service or bank service contexts to which the method and system of the present invention may apply. For example, the present invention may be implemented in other contexts including but not limited to checking accounts, debit accounts, traditional savings accounts, credit accounts, lines of credit and money market accounts

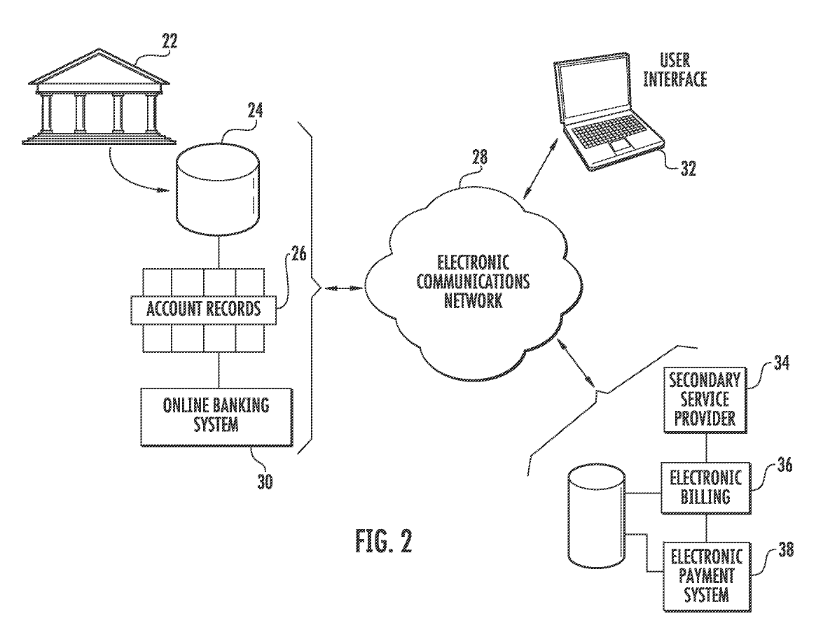

In a system particularly structured for the implementation of the present invention as depicted at FIG. 2, a customer establishes a new bank account with a bank service provider 22. The account records 26 relating to the all of the bank accounts at the bank service provider 22 are maintained on a server or database 24 that is connected to an electronic communications network 28 such as for example the Internet or the like. At the time of account enrollment, the customer also establishes the ability to conduct online banking and bill payment via the bank service provider's 22 online banking system 30 through a user interface 32 that also connected with the electronic communication network 28 and is accessed remotely by the customer. The customer is then provided with a code, voucher, coupon or the like that is employed in connection with obtaining services from a second vendor or secondary service provider 34 such as a voucher a mobile phone or an upgrade to an existing mobile phone for example.

Once the new bank account and secondary services are established they are linked with one another such that electronic bills generated by the secondary service provider's 34 electronic billing system 36 are transmitted to their bank service provider's 22 account record system 26 via the electronic communications network 28. Further, the bank service provider 22 then transmits payment of the electronic bills received to the secondary service provider 34 via the electronic communications network 28 for settlement in the secondary service provider's 34 electronic payment system 38. Using the mobile phone example, they are linked by the customer enrolling their mobile phone account for receipt of electronic bills within their bank account. Bank accounts and secondary services that are linked in this manner then become eligible for an incentive or discounted service as was described in detail in the method above.

It can therefore be seen that the present invention provides a system and method for that enables a bank service provider or another similarly situated entity to offer an attractive incentive to customers to encourage the use of their account services or the use of preferred services offered by the service provider in exchange for a discount on services offered by a second vendor. In addition, the present invention provides a method and system that allows a bank service provider to cross promote with a second vendor in a manner that creates increased customer loyalty and brand awareness thereby deepening the customer relationship with the two program providers. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method for linking an account that is administered by a bank service provider with services offered by a secondary service provider comprising:
establishing an account at a bank service provider for the benefit of an account holder, said account including online banking and online bill payment features;
enrolling for secondary services from said secondary service provider;
linking said secondary services with said account for the exchange of electronic billing and electronic payment transactions; and
providing a discount or incentive for the use of said secondary services.

2. The method of claim 1, further comprising the step of:
downloading software from said bank service provider for use in conjunction with said secondary services.

3. The method of claim 1, wherein said secondary services are cell phone services.

4. The method of claim 3, further comprising:
providing a voucher for a free cell phone or cell phone upgrade.

5. The method of claim 3, wherein said cell phone services include text messaging services, said discount making said text messaging services free.

6. The method of claim 5, further comprising:
providing a voucher for a free cell phone or cell phone upgrade.

7. The method of claim 3, further comprising the step of:
downloading software from said bank service provider for use on said cell phone.

8. The method of claim 1, wherein said bank service provider reimburses said secondary service provider for said incentive or discount.

9. The method of claim 1, wherein said bank service provider reimburses said secondary service provider for a portion of said incentive or discount.

10. A system for linking an account that is administered by a bank service provider with services offered by a secondary service provider comprising:
an account maintained at a bank service provider for the benefit of an account holder, said account being in communication with an electronic communications network, said account accessible via a user interface also in communication with said electronic communications network thereby allowing online banking and online bill payment features; and
secondary services provided by said secondary service provider, said secondary service provider linking to said account via said electronic communications network for the exchange of electronic billing and electronic payment transactions,
wherein a discount or incentive is provided for the use of said secondary services.

11. The system of claim 10, wherein software is downloaded from said bank service provider for use in conjunction with said secondary services.

12. The system of claim 10, wherein said secondary services are cell phone services.

13. The system of claim 12, further comprising:
said bank service provider providing a voucher for a free cell phone or cell phone upgrade.

14. The system of claim 12, wherein said cell phone services include text messaging services, said discount making said text messaging services free.

15. The system of claim 14, further comprising:
said bank service provider providing a voucher for a free cell phone or cell phone upgrade.

16. The system of claim 12, wherein software is downloaded from said bank service provider for use in conjunction with said secondary services.

17. The system of claim 10, wherein said bank service provider reimburses said secondary service provider for said incentive or discount.

18. The system of claim 10, wherein said bank service provider reimburses said secondary service provider for a portion of said incentive or discount.
